(19) United States
(12) Patent Application Publication
(10) Pub. No.: US 2016/0327185 A1
(43) Pub. Date: Nov. 10, 2016

(54) PERFORATED WRAP COVERING FOR PROTECTING COATED PIPE

(71) Applicants: Christopher L. Work, Jacksonville, TX (US); Kevin B. Inglehart, Jacksonville, TX (US); M. Derek Birdwell, Jacksonville, TX (US)

(72) Inventors: Christopher L. Work, Jacksonville, TX (US); Kevin B. Inglehart, Jacksonville, TX (US); M. Derek Birdwell, Jacksonville, TX (US)

(21) Appl. No.: 15/216,819

(22) Filed: Jul. 22, 2016

Related U.S. Application Data
(63) Continuation-in-part of application No. 14/807,815, filed on Jul. 23, 2015.
(60) Provisional application No. 62/028,284, filed on Jul. 23, 2014.

(51) Int. Cl. F16L 1/11; F16L 57/06

(52) U.S. Cl. CPC F16L 1/11; F16L 57/06

(57) ABSTRACT

A perforated wrap-type covering protects coatings for buried pipes from damage by rocks and abrasive fill. The protective covering is a sheet of polymeric material, preferably 80 mil (2.03 mm) thick low density polyethylene, having an array of fluid communication perforations on one-inch centers, both longitudinally and laterally, and ranging in diameter from 1/16 inch to 3/16 inch (1.5 mm to 4.8 mm), to allow moisture to contact the coated pipe and provide current paths between the coated pipe, through the soil and to sacrificial anodes. The protective covering preferably has mounting holes which are spaced apart in rows which extend about respective circumferences of a pipe being coated. The protective covering is unrolled, then place around the pipe so that the diameter of the pipe is perpendicular to the length of the covering, and then the opposed edges over the protective covering are secured via cable ties.

### CROSS-REFERENCE TO RELATED APPLICATION

The present application is a continuation-in-part of U.S. patent application Ser. No. 14/807,815, filed Jul. 23, 2015, and entitled “Covering for Underground Pipes and Related Methods,” which claims the priority and benefit of U.S. Provisional Patent Application No. 62/028,284 entitled “Covering for Underground Pipes and Related Methods” filed Jul. 23, 2014.

### TECHNICAL FIELD OF THE INVENTION

The present invention relates in general to protective coverings for underground pipes, and in particular to a protective wrap for protecting buried coated pipe.

### BACKGROUND OF THE INVENTION

Protective wraps have been provided for covering buried pipes to prevent damage to coatings for the pipes caused by crushing against rocks in the soil or rubbing against abrasive bedding materials. A problem arises with protective wraps used in underground installations for protecting coated when the protective wraps interfere with cathodic protection systems deployed to prevent pipe corrosion. In such systems, conductive metal pipes are included as cathodes for electrolytic cells and are electrically connected to sacrificial anodes. Such cathodic protection systems require that an electric circuit be completed from the sacrificial anodes, through the metal pipes, and back to the anodes through the soil. A non-conductive wrap can act as a moisture barrier, breaking a cathodic protection circuit by preventing current from flowing through the soil between the protected metal pipe and the sacrificial anode, defeating conventional cathodic protection systems. Pipes used for underground installation are typically coated with an epoxy or plastic material. If the coating delaminates from the surface of the pipe, moisture will typically migrate between the delaminated coating and the surface of the pipe setting up a small electrolytic cell and corrosion of the pipe will occur when cathodic protection systems are rendered ineffective. A need exists for a protective wrap for underground pipes that is inexpensive and can be readily installed at a job site, and which does not interfere with conventional cathodic protection systems.

### SUMMARY OF THE INVENTION

A protective wrap-type covering for underground pipes is provided by a rectangular sheet of a flexible waterproof protective material capable of being wrapped around a pipe. The rectangular sheets have markings near the edges of the length of the rectangle which are fixed and equidistance from one another. In a preferred embodiment, the rectangular sheets are 22 to 26 feet wide, cut to a desired diameter in the field, 400 feet (122 meters) long, 80 mils (2.03 mm) thick, with perforations having a diameter of approximately 3/16 inches (4.8 mm). The rectangular sheets are preferably formed of 40 mil (1.02 mm) to 120 mil (3.05 mm) low density polyethylene sheets and have fluid communication perforations on 25 mm (one inch) centers, both longitudinally and laterally spaced, and preferably ranging in diameter from approximately 1/16 inch to 5/16 inch (1.5 mm to 8 mm), allowing moisture to contact the coated pipe to provide current paths between the coated pipe, the soil and sacrificial anodes of cathodic protection systems. For thicker sheets, perforation diameters may be sized to approximately ½ inch (12 mm). A method is provided for protecting an underground pipes comprising: unrolling a roll of a flexible covering; placing the unrolled flexible covering adjacent to the pipe to be wrapped; wrapping the flexible covering around the pipe so that the diameter of the pipe is perpendicular to the length of the covering; securing the covering to the pipe using cable ties to wrap around a respective circumference of the pipe. Mounting holes are provided in the protective cover for receiving the cable ties, preferably with respective rows of mounting holes extending around a respective circumferences of the pipe for weaving cable ties through mounting holes in a selected row and about a respective circumference of the pipe.

### DESCRIPTION OF THE DRAWINGS

For a more complete understanding of the present invention and the advantages thereof, reference is now made to the following description taken in conjunction with the accompanying Drawings in which FIGS. 1 through 4 show various aspects for a protective covering with moisture apertures for underground pipes devices made according to the present invention, as set forth below:

FIG. 1 is a partial perspective view of a protective cover that has been laid flat;

FIG. 2 is a partial perspective view of a pipe that has been wrapped with the protective cover;

FIG. 3 is an environmental view of a coated pipe wrapped with the protective covering; and

FIG. 4 is a perspective view of a cable tie used to secure the protective cover.

### DETAILED DESCRIPTION OF THE INVENTION

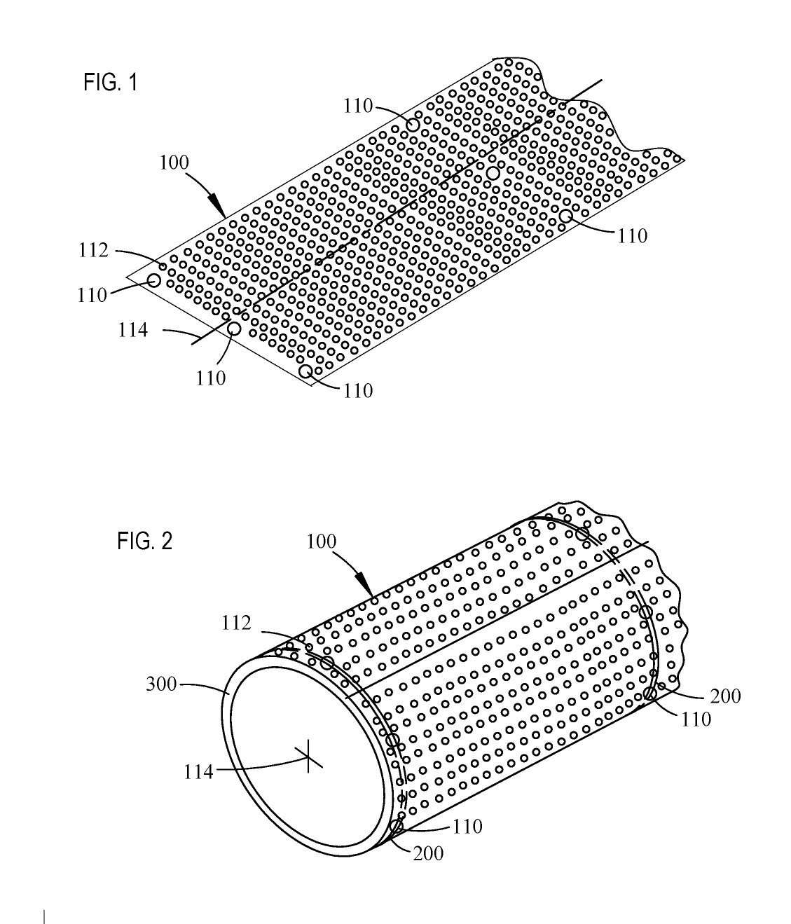

FIG. 1 is a partial, perspective view of the preferred embodiment of a protective covering 100. FIG. 1 shows the covering 100 after it has been unrolled and laid flat. The covering 100 preferably will be made and sold in rolls, so it can easily be transported to and from a job site, with to rolls suspended from yokes which allow the protective covering to be applied to a long pipe section, up to 400 feet (122 meters) long. A longitudinal axis 114 runs the length of the covering 100, perpendicular to a later direction or width of the covering 100. The covering 100 is preferably a sheet of low density polyethylene, but may also be a different pliable polymer, such as high density polyethylene. In some embodiments, the covering 100 may be provided by composite layers of polyethylene, or other flexible polymer, having a central layer providing a pliable core, such as that provided by having a honeycomb structure. Preferably, the protective cover 100 is a layer of low density polyethylene having a thickness of 80 mils (2.03 mm), but other thicknesses maybe provided such as those within a range of 40 mils (1.02 mm) to 120 mils (3.05 mm). The width of the cover 100 is based on the diameter of the pipe to be covered, which often range in size from sixteen inches (40 cm) to forty-two inches (107 cm). The width is cut from rolls of polyethylene sheets measuring from 22 feet to 26 feet (6 meters to 8 meters), by 400 feet (122 meters) in length.

Still referring to FIG. 1, the preferred embodiment of the covering 100 features mounting holes 110 which are preferably ⅝ inches (16 mm) in diameter and spaced apart in rows 6 inches in a lateral direction, which defines the width of the covering 100, which is perpendicular to the longitudinal axis 114. The rows are preferably spaced apart 3 feet along the longitudinal axis 114 of the protective cover 100. The mounting holes 110 assist with the installation process and accommodate cable ties (see FIG. 2, element 200; see also FIG. 4, element 200). Cable ties 200 are woven into respective ones of the rows of mounting holes 110, alternative passing above and beneath the protective covering 100 at adjacent ones of the mounting holes 110 in a row circumferentially extending around the coated pipe being covered. The mounting holes 110 may be located on one end or both ends of the covering 100. In some embodiments, instead of holes, the covering 100 may feature guide markings preprinted on the covering. In other embodiments, the covering 100 may feature extruded holes or an adhesive for zip ties to be inserted into the covering 100. The covering 100 may also be clear and transparent to see engineering numbers and locations of welds.

The protective cover 100 is preferably a rectangular sheet which is perforated with an array of fluid communication perforations 112 to allow moisture to pass for completing an electric circuit for cathodic protection. The perforations 112 preferably through-holes, extending fully through the protective cover 100, and have a diameter of approximately 4.8 mm ( 3/16 inches). The rectangular sheets 100 are preferably formed of 40 mils (1.02 mm) to 120 mils (3.05 mm) low density polyethylene sheets and have perforations on approximately 25 mm (one inch) centers, both longitudinally and laterally spaced, and preferably ranging in diameter from approximately 1/16 inch to 5/16 inch (1.5 mm to 8 mm), allowing ground moisture to pass through the protective cover and contact the coated pipe to provide current paths between the coated pipe, the soil and sacrificial anodes of cathodic protection systems. For thicker sheets, perforation diameters may be sized to approximately ½ inch (12 mm). In some circumstances, larger spacings may be use between the fluid communication perforation 112 than one inch (24 mm) centers. In some embodiments, interior layers of the rectangular sheets are conductive, provided by mixing graphite or carbon black with the polyethylene resins during manufacture, and larger spacing and smaller holes may be used. In some embodiments, the rectangular sheets may be formed of two more plies of low density polyethylene sheeting, with one of the layers being expanded or of a honeycomb shape to provide resiliency to protect against the pipe coating being crushed.

FIG. 2 is a perspective view that shows that covering 100 after it has been applied to a pipe 300. In the preferred embodiment, the covering 100 fully surrounds the diameter of the pipe 300 with little or no overlap. The covering is held in place with the use of cable ties 200. The cable ties 200 are inserted into the holes 110 of the covering 100 and fastened securely

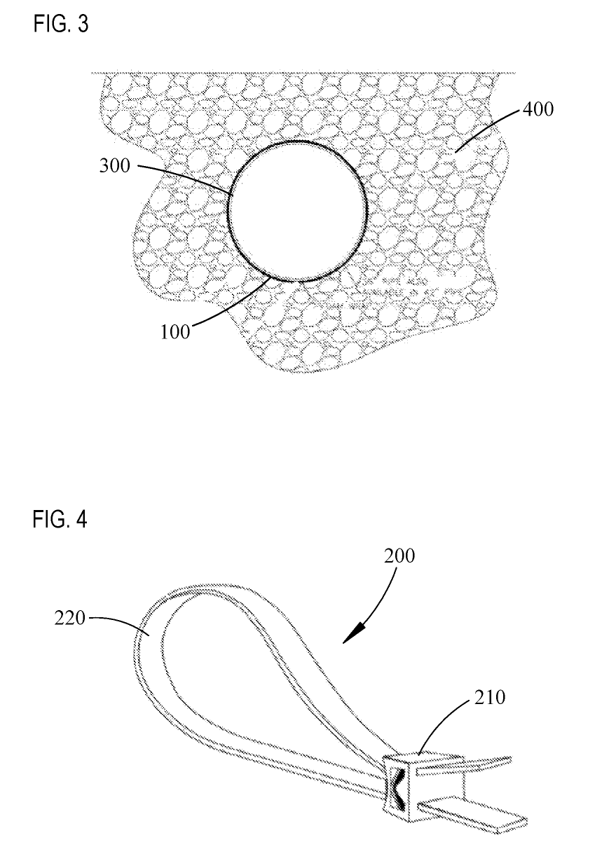

FIG. 3 shows an environmental view of a covered pipe 300 in the ground 400. As depicted in FIG. 3, the ground 400 features hazards such as rough terrain and rocks that can potentially damage the pipe 300.

FIG. 4 is a perspective view of a cable tie 200. The cable tie 200 features a strip 220 and a clasp 210. The strip 220 is preferably made from nylon, but can be made from another polymer. In the preferred embodiment, the strip 220 is 0.036 inches thick and one half inch wide. The strip 200 preferably is made in fifty, one hundred, or two hundred foot rolls and can be cut to a custom length. The cable tie 200 features a clasp 210. The clasp 210 is preferably a one-way double locking head with stainless steel locking teeth that offers four hundred pounds of tensile strength. The cable tie 200 will lock the covering 100 tightly in place and will not stretch or slide.

In an alternate embodiment, the cable ties may be embedded along the covering 100 or pre-installed into the holes 110 of the covering 100 in order to make installation easier. A protective cover 100 with an array of fluid communication perforations 112 may also be used for non-coated conductive pipe protected by cathodic protection systems.

In one embodiment, the protective covering 100 is applied to a pipe 300 by a user first rolling out the covering 100 so that it is laid flat. If needed, the user may have to cut the covering 100 to the desired length. The user then wraps the covering 100 around the diameter of a pipe 300. The protective cover 100 may be laid over the pipe to be covered in roll form, using a yoke suspended from a crane, host, or the like, to hold the roll above a section of the pipe and spool the protective covering 100 out over the pipe. The user secures the covering 100 to the pipe 300 by encircling the covered pipe 300 with a strip 220 and tightly securing the strip 220 with a clasp 210. In some embodiments, the user will weave the strip 220 through at least one hole 110 on one or both sides of the covering 100. The user will continue to secure the covering 100 onto the pipe 300 by placing cable ties 200 approximately every three feet (91 cm) until the user reaches the end of the pipe 300.

Although the preferred embodiment has been described in detail, it should be understood that various changes, substitutions and alterations can be made therein without departing from the spirit and scope of the invention as defined by the appended claims.

What is claimed is:

1. A protective covering for underground pipes comprising:
a flexible sheet of a protective material capable of being rolled, and of a thickness to prevent the underground pipes from being damaged when buried from contact with earthen materials;
fluid communication perforations extending through said sheet of protective material, said perforations being disposed in spaced apart relation to extend in longitudinal and lateral directions along said sheet of protective material; and
said fluid communication perforations being sized to extend through said sheet of protective material to pass ground moisture and provide a conductive circuit path between the underground pipes and soil.

2. The protective covering according to claim 1, wherein said fluid communication perforations are on one-inch (25 mm) centers, both longitudinally and laterally relative to said sheet of conductive material.

3. The protective covering according to claim 1, wherein said fluid communication perforations range in size from approximately one-sixteenth inch (1.5 mm) to 5/16 inch (8 mm).

4. The protective covering according to claim 1, further comprising mounting holes formed to extend through said protective cover, said mounting holes being configured for passing tie members there-through to secure said protective cover to the underground pipe being buried.

5. The protective covering according to claim 4, wherein said mounting holes are aligned into rows, each row circumferentially extending around a central longitudinal axis of the pipe being covered, with said mounted holes being spaced apart substantially equal distances about a respective row.

6. The protective covering according to claim 5, wherein said tie members are woven into respective ones of said rows of said mounting holes, alternatively passing above and beneath the protective covering at adjacent ones of the mounting holes in said row of said mounting holes which circumferentially extending around the pipe being covered.

7. The protective covering according to claim 5, wherein said tie members are cable ties and said mounting holes are configured for receiving said cable ties, and
wherein said mounting holes are larger in width than said fluid communication perforations.

8. The protective covering according to claim 6 wherein the sheet of protective material is formed of polyethylene.

9. The protective covering according to claim 6 wherein the sheet of protective material is formed of a low density polyethylene.

10. A protective covering for underground pipes comprising:
a flexible, rectangular sheet formed of polyethylene and of a thickness to prevent the coated pipes from being damaged from contact with earthen materials during installation into the ground;
fluid communication perforations extending through said sheet of protective material, said fluid communication perforations being disposed in an array in spaced apart relation to extend in longitudinal and lateral directions along said sheet of protective material; and
said perforations being sized to extend through said rectangular sheet to pass ground moisture and provide a conductive circuit path between the underground pipes and soil.

11. The protective covering according to claim 10, wherein said fluid communication perforations are on one-inch (25 mm) centers, both longitudinally and laterally relative to said sheet of conductive material.

12. The protective covering according to claim 10, wherein said fluid communication perforations range in size from approximately one-sixteenth inch (1.5 mm) to 5/16 inch (8 mm).

13. The protective covering according to claim 10, further comprising mounting holes formed to extend through said protective cover, said mounting holes being configured for passing tie members there-through to secure said protective cover to the underground pipe being buried.

14. The protective covering according to claim 13, wherein said mounting holes are aligned into rows, each row circumferentially extending around a central longitudinal axis of the pipe being covered, with said mounted holes being spaced apart substantially equal distances about a respective row.

15. The protective covering according to claim 15, wherein said tie members are woven into respective ones of said rows of said mounting holes, alternative passing above and beneath the protective covering at adjacent ones of the mounting holes in said row of said mounting holes which circumferentially extending around the pipe being covered.

16. The protective covering according to claim 15, wherein said tie members are cable ties and said mounting holes are configured for receiving said cable ties, and
wherein said mounting holes are larger in width than said fluid communication perforations; and
said rows of mounting holes are spaced apart approximately three feet (91 cm) along the longitudinal axis of the section of pipe being covered.

17. The protective covering according to claim 13 wherein the sheet of protective material is formed of low density polyethylene.

18. A protective covering for underground pipes comprising:
a flexible, rectangular sheet formed of 50 mil polyethylene for preventing the coated pipes from being damaged from contact with earthen materials during installation into the ground;
fluid communication perforations extending through said sheet of protective material, disposed in an array in spaced apart relation to extend in longitudinal and lateral directions along said sheet of protective material on one-inch (25 mm) centers; and
said fluid communication perforations being sized to extend through said rectangular sheet to pass ground moisture and provide a conductive circuit path between the underground pipes and soil.

19. The protective covering according to claim 18, further comprising mounting holes formed to extend through said protective cover, said mounting holes being configured for passing tie members there-through to secure said protective cover to the underground pipe being buried;
said mounting holes are aligned into rows, each row circumferentially extending around a central longitudinal axis of the pipe being covered, with said mounted holes being spaced apart substantially equal distances about a respective row; and
said tie members are woven into respective ones of said rows of said mounting holes, alternative passing above and beneath the protective covering at adjacent ones of the mounting holes in said row of said mounting holes which circumferentially extending around the pipe being covered.

20. The protective covering according to claim 19, wherein said fluid communication perforations range in size from approximately one-sixteenth inch (1.5 mm) to 5/16 inch (8 mm), and said mounting holes are ⅝ inch (16 mm) in diameter; and
said rows of mounting holes are spaced apart three feet (91 cm) in a longitudinal direction along the pipe being covered.
